(19) United States
(12) Patent Application Publication
(10) Pub. No.: US 2025/0350341 A1
(43) Pub. Date: Nov. 13, 2025

(54) METHODS ON BEAM PREDICTION FOR WIRELESS COMMUNICATION

(71) Applicant: INTERDIGITAL PATENT HOLDINGS, INC., Wilmington, DE (US)

(72) Inventors: Young Woo Kwak, Woodbury, NY (US); Moon IL Lee, Melville, NY (US); Prasanna Herath, Laval (CA); Yugeswar Deenoo Narayanan Thangaraj, Chalfont, PA (US)

(73) Assignee: INTERDIGITAL PATENT HOLDINGS, INC., Wilmington, DE (US)

(21) Appl. No.: 18/861,085

(22) PCT Filed: Apr. 28, 2023
(86) PCT No.: PCT/US2023/020315

§ 371 Date: Oct. 28, 2024

Related U.S. Application Data
(60) Provisional application No. 63/335,942, filed on Apr. 28, 2022.
(60) Provisional application No. 63/359,047, filed on Jul. 7, 2022.
(60) Provisional application No. 63/410,026, filed on Sep. 26, 2022.

(51) Int. Cl. H04B 7/06; H04L 41/16; H04W 72/23

(52) U.S. Cl. CPC H04B 7/0696; H04L 41/16; H04W 72/23

(57) ABSTRACT

A method performed by a wireless transmit/receive unit (WTRU) may compromise: transmitting, to a base station, Rx beam capability information; determining a Rx beam ID for each of one or more Rx beams of the WTRU; receiving, from the base station, information indicating a first reference signal (RS) resource set and a second RS resource set; determining an association between the first RS resource set and second RS resource set and one or more Tx beam IDs; determining a preferred beam pair, including a preferred Rx beam and preferred Tx beam; and transmitting, to the base station, information indicating a beam pair ID of the preferred beam pair.

### CROSS-REFERENCE TO RELATED APPLICATIONS

This application claims the benefit of U.S. Provisional Application No. 63/335,942, filed Apr. 28, 2022, U.S. Provisional Application No. 63/359,047, filed Jul. 7, 2022 and U.S. Provisional Application No. 63/410,026, filed Sep. 26, 2022, the contents of which are incorporated herein by reference.

### BACKGROUND

Beam measurement and reporting are necessary features for higher frequencies for finding an optimized beam and for supporting transmission and reception of physical downlink shared channel (PDSCH). However, traditional beam measurement and reporting methods are not efficient. For example, a wireless transmit/receive unit (WTRU) typically needs to measure whole combinations of gNode B (gNB) transmission beams and WTRU reception beams to identify the optimized beam. In addition, a gNB cannot simultaneously transmit multiple analog beams in different frequency resources with a same time resource. Therefore, optimizing reference signal (RS) measurement overheads and latency for measurement and reporting are crucial for wireless systems in higher frequencies. Accordingly, more efficient beam measurement and reporting methods are desirable.

### SUMMARY

A method performed by a wireless transmit/receive unit (WTRU) may compromise: transmitting, to a base station, Rx beam capability information; determining a Rx beam ID for each of one or more Rx beams of the WTRU; receiving, from the base station, information indicating a first reference signal (RS) resource set and a second RS resource set; determining an association between the first RS resource set and second RS resource set and one or more Tx beam IDs; determining a preferred beam pair, including a preferred Rx beam and preferred Tx beam; and transmitting, to the base station, information indicating a beam pair ID of the preferred beam pair.

The method may further compromise determining a beam application time duration based on a beam type of the preferred beam pair. The beam type may be a transmission beam or an estimation beam. The estimation beam may be based on a machine learning model. The machine learning model may be based on measurements of transmission beams. The method may further compromise receiving, using the preferred Rx beam, a physical downlink shared channel (PDSCH) transmission during the beam application time duration.

The Rx beam capability information may include at least one of number of a WTRU beams, a number of WTRU panels, a beam width, a beam position, or a beam granularity. The first RS resource set may include one or more RS resources for transmissions beams and the second RS resource set may include one or more resources for estimation beams. The association between the first RS resource set and the second resource set and the Tx beam IDs may be based on a beam configuration information . . .

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating hybrid beamforming according to an embodiment;

FIG. 3 is a diagram illustrating partial beam management according to an embodiment; and

FIG. 4 is a flowchart illustrating an example of a procedure for beam management based on partial measurement.

### DETAILED DESCRIPTION

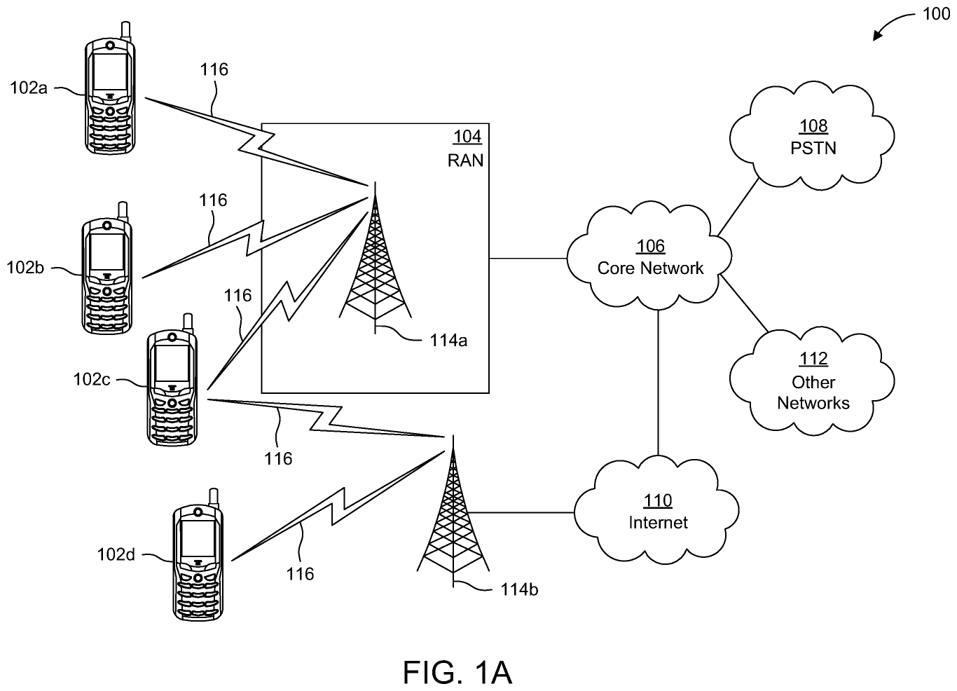

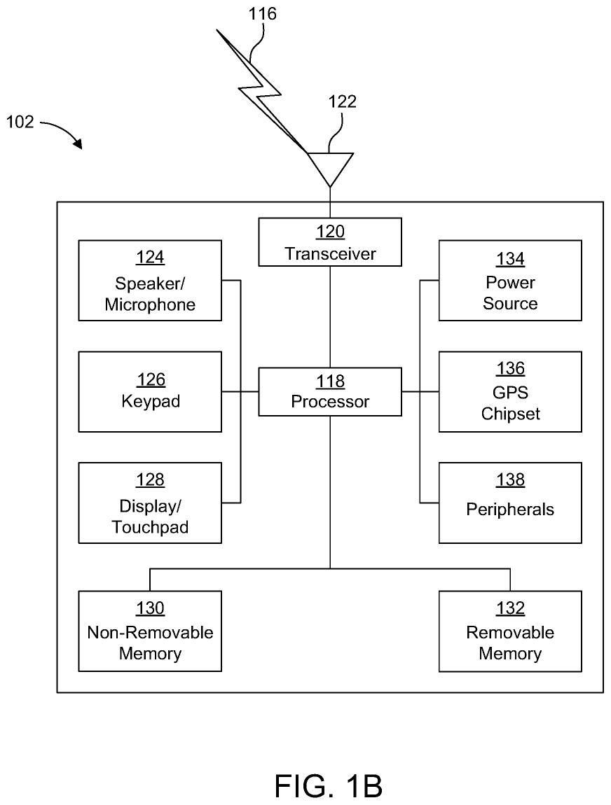

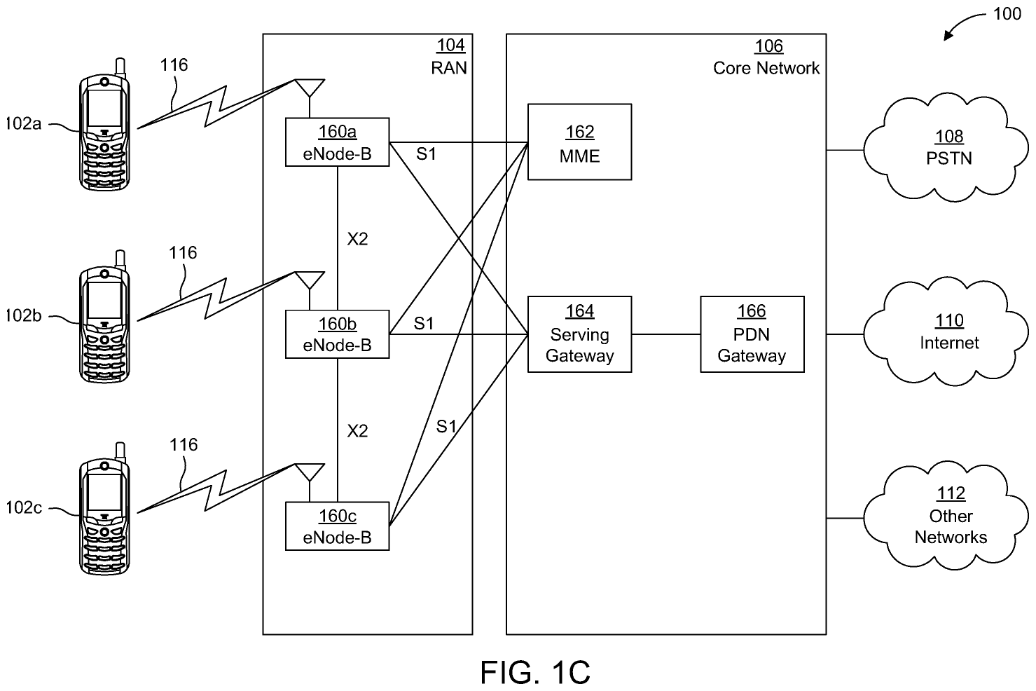

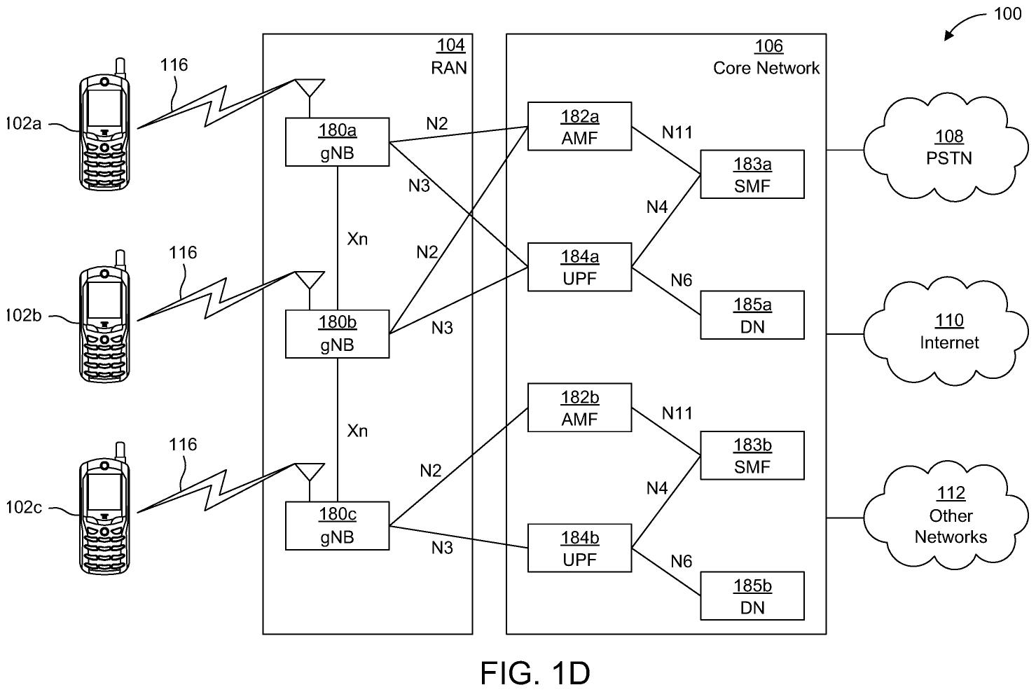

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Artificial intelligence (AI) may be broadly defined as the behavior exhibited by machines. Such behavior may include mimicking cognitive functions to sense, reason, adapt and act.

Machine learning may refer to a type of algorithms that solve a problem based on learning through experience (e.g., data), without explicitly being programmed (e.g., configuring a set of rules). Machine learning may be considered a subset of AI. Different machine learning paradigms may be envisioned based on the nature of data or feedback available to the learning algorithm. For example, a supervised learning approach may involve learning a function that maps input to an output based on labeled training example, wherein each training example may be a pair consisting of input and the corresponding output. For example, unsupervised learning approach may involve detecting patterns in the data with no pre-existing labels. For example, reinforcement learning approach may involve performing sequence of actions in an environment to maximize the cumulative reward. It is possible to apply machine learning algorithms using a combination or interpolation of the above-mentioned approaches. For example, a semi-supervised learning approach may use a combination of a small amount of labeled data with a large amount of unlabeled data during training. In this regard, semi-supervised learning falls between unsupervised learning (with no labeled training data) and supervised learning (with only labeled training data).

Deep learning may refer to a class of machine learning algorithms that employ artificial neural networks, which are loosely inspired from biological systems. Deep Neural Networks (DNNs) are a special class of machine learning models inspired by the human brain wherein the input is linearly transformed and passed through non-linear activation functions multiple times. DNNs typically consists of multiple layers where each layer consists of linear transformation and a given non-linear activation function. The DNNs may be trained using the training data via a back-propagation algorithm. Recently, DNNs have shown state-of-the-art performance in variety of domains (e.g., speech, vision, natural language, etc.), and for various machine learning settings (e.g., supervised, un-supervised, and semi-supervised). Artificial Intelligence Markup Language (AIML) based methods and/or processing may refer to a realization of behaviors and/or conformance to requirements by learning based on data, without explicit configuration of sequence of steps of actions. Such methods may enable learning complex behaviors which may be difficult to specify and/or implement when using legacy methods.

New Radio (NR) has introduced radio access technology (RAT) in frequency range 2 (FR2), where FR2 denotes the frequency range of 24.25-52.6 GHz. One of key challenge of FR2 is higher propagation loss. Since propagation loss increases as carrier frequency increases, FR2 experiences higher propagation loss. In order to overcome the higher propagation loss, efficient usage of highly directional beamformed transmission and reception may be employed.

Beamforming gain may be achieved by adding or subtracting one signal from another signal. Since more beamforming gain may be achieved as more signals are added or subtracted, utilization of large number of antenna elements are essential for the highly directional beamformed transmission. Controlling signal addition or signal subtraction may be achieved by controlling phases of antenna elements.

Beamforming methods may be categorized into three types (i.e., analog beamforming, digital beamforming and hybrid beamforming) based on the phase controlling types. While the digital beamforming controls a phase of a signal by applying digital precoder, the analog beamforming controls the phase of the signal through phase shifters. Generally, the digital beamforming provides good flexibility (e.g., applying different phases for different frequency resource blocks), but requires more complex implementation. In contrast to the digital beamforming, the analog beamforming provides relatively simple implementation, but has limitations (e.g., same analog beam for entire frequency resources).

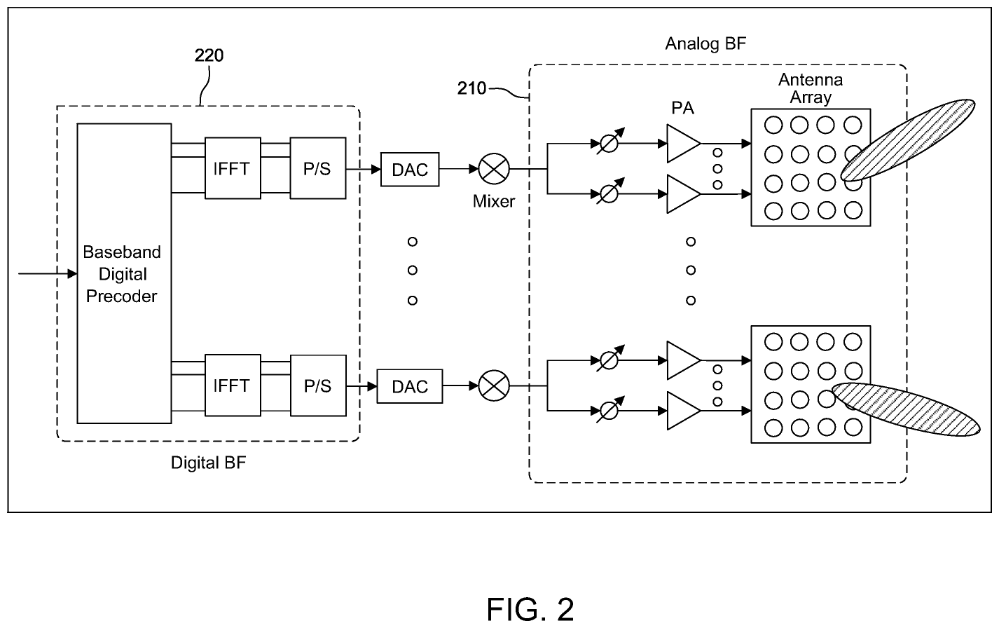

FIG. 2 is a diagram illustrating hybrid beamforming. As shown in FIG. 2, hybrid beamforming comprises both analog beamforming 210 for simple implementation and digital beamforming 220 for flexibility. Hybrid beamforming architecture may achieve large beamforming gain with reasonable implementation complexity. Hybrid beamforming may provide flexibility with reasonable implementation complexity by combining analog beamforming and digital beamforming.

The beam width of a beam may decrease as beamforming gain increases, and accordingly, the beam may only cover a limited area. Therefore, a base station and a WTRU may need to utilize multiple beams to cover the entire cell. For example, broadcast signals such as synchronization signal blocks (SSBs) may be transmitted along all directions (e.g., via beam sweeping) to cover the entire cell. For unicast transmission between the base station and the WTRU, procedures to optimize the beam direction to the WTRU may be provided through beam management. Beam management includes the selection and maintenance of the beam direction for unicast transmission (including control channel and data channel) between the base station and the WTRU.

Beam management procedures may be categorized into beam determination, beam measurement and reporting, beam switching, beam indication, and beam recovery. In beam determination, the base station and the WTRU may find a beam direction to ensure good radio link quality for the unicast control and data channel transmission. Once a link is established, the WTRU measures the link quality of multiple transmission (TX) and reception (RX) beam pairs and reports the measurement results to the base station. Furthermore, WTRU mobility, orientation, and channel blockage may change the radio link quality of TX and RX beam pairs. When the quality of the current beam pair degrades, the base station and the WTRU may switch to another beam pair with better radio link quality. To do so, the base station and the WTRU may monitor the quality of the current beam pair along with some other beam pairs and perform switching when necessary. When the base station assigns a TX beam to the WTRU via DL control signaling, the beam indication procedure may be used. Beam recovery entails a recovery procedure when a link between the base station and the WTRU can no longer be maintained.

In a study on AI/ML for NR Air interface the benefits of AI/ML for the air-interface were identified. In the study item, AI/ML model, terminology and description to identify common and specific characteristics for framework were investigated for the following use cases: Channel State Information (CSI) feedback enhancement (e.g., overhead reduction, improved accuracy, prediction), beam management (e.g., beam prediction in time, and/or spatial domain for overhead and latency reduction, beam selection accuracy improvement); and positioning accuracy enhancements for different scenarios including, e.g., those with heavy NLOS conditions.

As noted above, measurement and reporting are usually necessary features for higher frequencies (e.g., FR2-1 or FR2-2) for finding an optimized beam and for supporting transmission and reception of Physical Downlink Shared Channel (PDSCH). However, traditional beam measurement and reporting methods are not efficient. For example, a wireless transmit/receive unit (WTRU) typically needs to measure whole combinations of gNB transmission beams and WTRU reception beams to identify the optimized beam. In case of analog beams, a gNB cannot simultaneously transmit multiple analog beams in different frequency resources with a same time resource. Given the situation, optimizing Reference Signal (RS) measurement overheads and latency for measurement and reporting are crucial for wireless systems in higher frequencies.

The methods disclosed herein to efficiently utilize beam measurement and reporting. The methods disclosed may enable beam estimation based on partial beam measurement or beam hopping. In some embodiments, a base station (e.g., gNB) may transmit a part of beams among all beams that the base station supports and a WTRU may measure the part of beams and estimate quality of all beams without measuring other beams. Some embodiments may enable WTRU reporting based on partial beam measurement or beam hopping. In some embodiments, a WTRU may report one or more best beams which were not transmitted based on WTRU estimation. Some embodiments may enable time/frequency synchronization for beams a base station does not transmit. In some embodiments a WTRU may estimate time/frequency synchronization based on associations between beams. Some embodiments may enable handling of WTRU Rx beams. In some embodiments, a base station may indicate WTRU Rx beams (e.g., for beam reporting or PDSCH reception). In some embodiments, a WTRU may report WTRU Rx beams which the WTRU used for measuring reported best beams. Some embodiments may enable Al/ML type configuration or recommendation. In some embodiments, a WTRU may recommend a signaling method for processing beam measurements. In some embodiments, a WTRU may report measured/estimated fingerprints which enables base station reverse fingerprinting.

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving an RS (such as CSI-RS) or a synchronization signal block (SSB). In such case, the WTRU may be said to transmit the target physical channel or signal according to a spatial relation with a reference to such RS or SSB.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may transmit the first (target) physical channel or signal according to a spatial relation with a reference to the second (reference) physical channel or signal.

A spatial relation may be implicit, configured by RRC or signaled by MAC CE or DCI. For example, a WTRU may implicitly transmit Physical Uplink Shared Channel (PUSCH) and Demodulation Reference Signal (DM-RS) of PUSCH according to the same spatial domain filter as a Sounding Reference Signal (SRS) indicated by a SRS resource indicator (SRI) indicated in Downlink Control Information (DCI) or configured by Radio Resource Control (RRC). In another example, a spatial relation may be configured by RRC for a SRI or signaled by MAC Control Element (MAC CE) for a Physical Uplink Control Channel (PUCCH). Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as Physical Downlink Control Channel (PDCCH) or Physical Downlink Shared Channel (PDSCH) and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated an association between a CSI-RS or SS block and a DM-RS by an index to a set of TCI states configured by RRC and/or signaled by MAC CE. Such indication may also be referred to as a “beam indication”.

The term “a reference signal,” as used herein, may be used interchangeably with one or more of following: SRS, CSI-RS, DM-RS, phase tracking reference signal (PT-RS), and SSB.

The term “a channel,” as used herein, may be used interchangeably with one or more of following: PDCCH, PDSCH, PUCCH, PUSCH, and physical random access channel (PRACH).

The term “a RS resource set,” as used herein, may be used interchangeably with a RS resource and a beam group.

The term “beam reporting,” as used herein, may be used interchangeably with CSI measurement, CSI reporting and beam measurement.

The term “beam,” as used herein, may be used interchangeably with “TCI state”, “TCI state group”, or “beam pair”.

The term “a time slot,” as used herein, may be used interchangeably with time stamp, time window, time symbol, time resource, radio frame, subframe, time location, time occasion, and reporting occasion.

The term “beam ID,” as used herein, may be used interchangeably with “beam index”, or “beam pair ID”.

The term “prediction,” as used herein, may be used interchangeably with estimation, determination, extrapolation, and anticipation.

In some embodiments, a WTRU may be configured with one or more CSI report configurations. The CSI report configurations may comprise one or more of the following: report configuration type (e.g., periodic, semi-persistent on PUCCH, semi-persistent on PUSCH or aperiodic); report quantity (e.g., CRI-RI-PMI-CQI, CRI-RI-i1, CRI-RI-i1-CQI, CRI-RSRP, SSB-Index-RSRP, CRI-RI-LI-PMI-CQI, CRI-SINR, SSB-Index-SINR); report frequency configuration, such as CQI format indicator (wideband CQI or subband CQI), PMI format indicator (wideband PMI or subband PMI), and/or CSI reporting band; time restriction for channel measurements; time restriction for interference measurements; codebook configuration; group based beam reporting; CQI table; subband size; non-PMI port indication; report slot config/offset list; CSI report periodicity and offset; one or more PUCCH resources for CSI reporting; and/or port index.

In some embodiments, a WTRU may be configured with one or more CSI measurement configurations. The CSI measurement configurations may include one or more of the following: RS for channel measurement; RS for interference measurement (zero power or non-zero power); report trigger size; aperiodic trigger state list; semi-persistent on PUSCH trigger state list; associated CSI resource configurations; and/or associated CSI report configurations.

In some embodiments, a WTRU may be configured with one or more CSI resource configurations. The CSI resource configuration may include one or more of the following: CSI resource configuration ID; one or more RS resource sets for channel measurement; one or more RS resource sets for interference measurement; bandwidth part ID; and/or resource type (e.g., aperiodic, semi-persistent or periodic).

In some embodiments, a WTRU may be configured with one or more resource sets. The RS resource set configuration may include one or more of the following: RS resource set ID; one or more RS resources for the RS resource set; repetition (i.e., on or off); aperiodic triggering offset (e.g., one of 0-6 slots); and/or TRS information (e.g., true or not).

In some embodiments, a WTRU may be configured with one or more RS resources. The RS resource configuration may include one or more of the following: RS resource ID; resource mapping (e.g., REs in a PRB); power control offset (e.g., one value of −8, . . . , 15); power control offset with SS (e.g., −3 dB, 0 dB, 3 dB, 6 Db); scrambling ID; periodicity and offset; and/or QCL information (e.g., based on a TCI state).

In some embodiments, a WTRU may measure a part of all beams and estimate/determine qualities (e.g., Reference Signal Received Power (RSRP), reference signal received quality (RSRQ), signal-to-interference-plus-noise ratio (SINR), Channel Quality Indicator (CQI), hypothetical PDCCH block error rate (BLER), etc.) of all beams based on the measurement of the part of all beams (e.g., partial beam measurement). For example, the WTRU may be indicated/configured with X beams (e.g., 64 beams) for the estimation, however, the WTRU may receive Y beams (e.g., 4, 8 or 16 beams) for measurement. Based on the measurement of the Y beams, the WTRU may estimate qualities of the X beams and may report one or more qualities of the estimated qualities (e.g., to a gNB).

In some embodiments, a WTRU may measure a part of all beams at one transmission cycle, measure multiple parts of all beams at multiple transmission cycles and estimate/determine qualities (e.g., RSRP, RSRQ, SINR, CQI, hypothetical PDCCH BLER, etc.) of all beams based on the measurement of the multiple parts at multiple transmission cycles (e.g., beam hopping). For example, the WTRU may be indicated/configured with X beams (e.g., 64 beams) for the estimation and the transmission. In addition, the WTRU may receive an indication and/or a configuration beam hopping pattern of the X beams. For example, the WTRU may receive first Y beams in RS resources in a first transmission cycle and second Y beams in the RS resources in a second transmission cycle. The WTRU may estimate qualities of the X beams and may report one or more qualities of the estimated qualities (e.g., to a base station).

In an embodiment, a WTRU may transmit a part of all beams and receive and/or determine a beam for signal transmission based on the part of all beams (e.g., partial beam measurement). For example, the WTRU may be indicated/configured with X beams (e.g., 16 beams) for the beam determination, however, the WTRU may transmit Y beams (e.g., 2, 4 or 8 beams) for transmission. Based on the transmission of the Y beams, the WTRU may receive an indication of one or more beams of the X beams for transmitting one or more channels and/or signals.

In another embodiment, a WTRU may transmit a part of all beams at one transmission cycle, transmit multiple parts of all beams at multiple transmission cycles. For example, the WTRU may be indicated/configured with X beams (e.g., 16 beams) for the transmission. In addition, the WTRU may receive an indication and/or a configuration beam hopping pattern of the X beams. For example, the WTRU may transmit first Y beams in RS resources in a first transmission cycle and second Y beams in the RS resources in a second transmission cycle.

One or more of modes of operation may be used for partial beam measurement, and/or transmission, and/or beam hopping.

In some embodiments, a mode of operation may be determined based on configurations associated with beam information for beams to be transmitted (e.g., transmission beams) and/or beams to be estimated/reported (e.g., estimation beams). For example, if a WTRU is configured without beam information, the WTRU may determine a first mode of operation (e.g., full beam measurement without beam hopping). If the WTRU is configured with beam information for transmission beams and/or estimation beams, the WTRU may determine a second mode of operation (e.g., partial beam measurement and/or beam hopping). The beam information may include one or more of the following: number of transmission beams (the WTRU may receive one configuration for each of horizontal/vertical domains); number of estimation beams (the WTRU may receive one configuration for each of horizontal/vertical domains); coverage of transmission beams (e.g., angular coverage such as 120 degrees); coverage of estimation beams (e.g., angular coverage such as 60 degrees); position/center of transmission beams (e.g., 0 degrees); position/Center of estimation beams (e.g., 0 degrees); granularity of transmission beams (e.g., 3 degrees) (the WTRU may receive one configuration for each of horizontal/vertical domains); and/or granularity of estimation beams (e.g., 12 degrees) (the WTRU may receive one configuration for each of horizontal/vertical domains).

A mode of operation may be determined based on use of beam ID. For example, if a WTRU is not configured to use beam IDs, the WTRU may determine a first mode of operation (e.g., full beam measurement/transmission without beam hopping). If the WTRU is configured to use beam IDs, the WTRU may determine a second mode of operation (e.g., partial beam measurement/transmission and/or beam hopping).

In an embodiment, a mode of operation may be determined based on WTRU capability associated with beam information for beams to be transmitted (e.g., transmission beams) and/or beams to be estimated/reported (e.g., estimation beams). For example, if a WTRU does not report beam information, the WTRU may determine a first mode of operation (e.g., full beam transmission without beam hopping). If the WTRU reports its beam information for transmission beams and/or estimation beams, the WTRU may determine a second mode of operation (e.g., partial beam transmission and/or beam hopping). The beam information may include one or more of the followings parameters: number of transmission beams (the WTRU may report the information for each of horizontal/vertical domains); number of estimation beams (the WTRU may report the information for each of horizontal/vertical domains); coverage of transmission beams (e.g., angular coverage such as 120 degrees); coverage of estimation beams (e.g., angular coverage such as 60 degrees); position/center of transmission beams (e.g., 0 degrees); position/center of estimation beams (e.g., 0 degrees); granularity of transmission beams (e.g., 3 degrees) (the WTRU may report the information for each of horizontal/vertical domains); and/or granularity of estimation beams (e.g., 12 degrees) (the WTRU may report the information for each of horizontal/vertical domains).

A mode of operation may be determined based on configurations of one or more beam IDs for RS resources/resource sets. For example, if a WTRU is configured without beam IDs, the WTRU may determine a first mode of operation (e.g., full beam measurement/transmission without beam hopping). If the WTRU is configured with beam IDs, the WTRU may determine a second mode of operation (e.g., partial beam measurement/transmission and/or beam hopping).

A beam identity (beam ID) may be referred to as an identity of a beam which may be a direction of signal transmitted/received in vertical and/or horizontal dimensions. A beam identity may be determined based on at least one of angle of departure (AoD), angle of arrival (AoA) in vertical and/or horizontal dimensions, measurement reference signal associated with, and geographical location of antenna.

In some embodiments, a mode of operation may be determined based on configurations of RS resources/resource sets for transmission beams and/or estimation beams. For example, if a WTRU is configured without configurations of RS resources/resource sets for transmission beams and/or estimation beams, the WTRU may determine a first mode of operation (e.g., full beam measurement without beam hopping). If the WTRU is configured with of RS resources/resource sets for transmission beams and/or estimation beams, the WTRU may determine a second mode of operation (e.g., partial beam measurement and/or transmission and/or beam hopping).

In some embodiments, a mode of operation may be determined based on configurations for beam hopping. For example, if a WTRU is configured without configurations for beam hopping, the WTRU may determine a first mode of operation (e.g., full beam measurement and/or transmission without beam hopping). If the WTRU is configured with beam hopping configuration for transmission beams and/or estimation beams, the WTRU may determine a second mode of operation (e.g., partial beam measurement and/or beam hopping). The beam hopping configuration may include one or more of following: hopping periodicity, hopping time offset, hopping bandwidth, and/or hopping type (e.g., beam hopping or beam group hopping).

In some embodiments, a mode of operation may be determined based on a number of transmission beams and a number of estimation beams. For example, if a WTRU is configured with a number of transmission beams which is equal to a configured number of estimation beams, the WTRU may determine a first mode of operation. If the WTRU is configured with a number of transmission beams which is not equal to the configured number of estimation beams (e.g., number of transmission beams>number of estimation beams), the WTRU may determine a second mode of operation.

In some embodiments, a mode of operation may be determined based on a WTRU capability and gNB configuration based on the WTRU capability reporting.

In some embodiments, a WTRU may request its preferred mode of operation for full beam measurement without hopping and partial beam measurement/beam hopping. For example, if a WTRU is capable to support both modes of operation (e.g., full beam measurement and/or transmission without hopping and partial beam measurement/beam hopping) and the measurement at the WTRU indicates a preferred mode of operation, the WTRU may indicate to gNB for the preferred mode of operation. For example, if measured accuracy of beam estimation is smaller than or equal to a threshold, the WTRU may indicate a first mode of operation (e.g., full beam measurement and/or transmission without hopping) as a preferred mode of operation. If the measured accuracy of beam estimation is higher than the threshold, the WTRU may indicate a second mode of operation (partial beam measurement/beam hopping).

In some embodiments, a threshold may be based on one or more of a predefined value, a preconfigured/indicated value by gNB (e.g., based on one or more of RRC, MAC CE and DCI), a determined value by a WTRU, etc.

In some embodiments, a WTRU may measure only selected beams and estimate qualities of other beams (e.g., partial beam measurement). For example, a WTRU may receive, or indicate (e.g., via WTRU capability), one or more of the below described configurations for partial beam measurement.

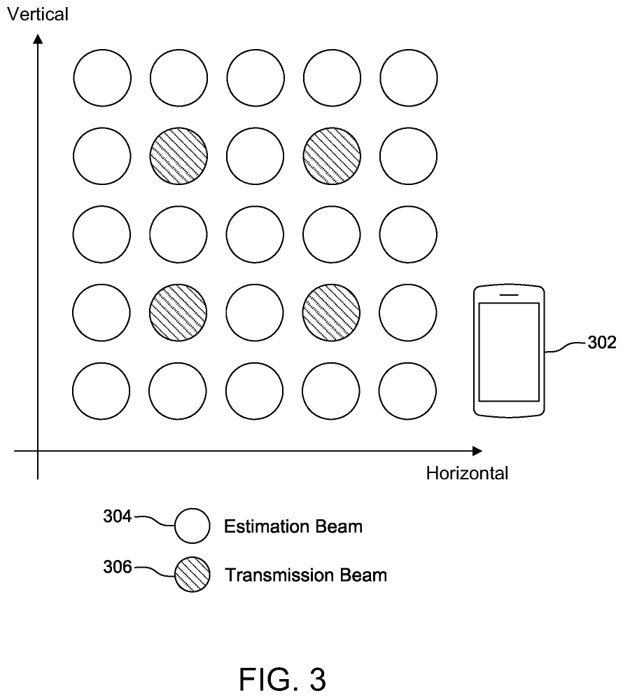

FIG. 3 illustrates an example of partial beam measurement and/or transmission. As shown in FIG. 3, in some embodiments, a WTRU 302 may receive a configuration of two RS resource sets. In one example, a first RS resource set may be for transmission beams 306 and a second RS resource set may be for estimation beams 304. In another example, a first RS resource set may be for transmission beams 306 and estimation beams 304 and a second RS resource set may be only for estimation beams 304.

A WTRU may receive a configuration of associated estimation beams or associated transmission beams. For example, the WTRU may receive a configuration of RS resource set ID for estimation beams/transmission beams in a configuration of RS resource set for transmission beams/estimation beams.

A WTRU may receive a configuration and/or an indication that indicates a measurement type (e.g., normal, transmission beam or estimation beam) of a RS resource set for the configured RS resource sets. For estimation beams, the WTRU may receive a configuration of one or more adjacent RS resources to identify beam characteristics (e.g., Doppler shift, delay spread, spatial characteristics and etc.). For example, the WTRU may receive a configuration of a beam ID with QCL information comprising a reference RS (e.g., QCL Type D) for transmission beams for a first RS resource set. The WTRU may receive a configuration of a beam ID with QCL information comprising two or more reference RSs (e.g., QCL Type D or other QCL Types) for estimation beams for a second RS resource set. The WTRU may receive a configuration of one or more beam IDs and/or QCL Info (e.g., including QCL Type D). For example, The WTRU may receive a configuration of a beam ID and QCL information for transmission beams for a first RS resource set. The WTRU may receive a configuration of a beam ID without QCL information for estimation beams for a second RS resource set.

In some embodiments, one or more of the following beam information for transmission beams and/or estimation beams may be configured, indicated and/or predefined: number of transmission beams (the WTRU may receive one configuration for each of horizontal/vertical domains); number of estimation beams (the WTRU may receive one configuration for each of horizontal/vertical domains); coverage of transmission beams (e.g., angular coverage such as 120 degrees); coverage of estimation beams (e.g., angular coverage such as 60 degrees); position/Center of transmission beams (e.g., 0 degree); position/Center of estimation beams (e.g., 0 degree); granularity of transmission beams (e.g., 3 degrees) (the WTRU may receive one configuration for each of horizontal/vertical domains); granularity of estimation beams (e.g., 12 degrees) (the WTRU may receive one configuration for each of horizontal/vertical domains); WTRU panel related information (e.g. number WTRU panels, position/center/direction of WTRU panels); number of gNB TRPs and or panels (e.g. number of gNB TRPs and/or panels, and position/center/direction of gNB TRPs and or panels). With respect to the number of transmission beams, and the number of estimated beams, the WTRU may indicate one configuration (e.g., via WTRU capability) for each of horizontal/vertical domains.

Based on the configuration and/or the predefined rules, the WTRU may determine required information of transmission/estimation beams. In some embodiments, the WTRU may determine a number of transmission beams and/or estimation beams based on the configured beam information. For example, the WTRU may divide the indicated coverage (e.g. 120 degrees) of transmission/estimation beams into granularity angle (e.g. 10 degrees) of transmission/estimation beams to determine number of transmission beams and/or estimation beams (e.g., 12). The WTRU may measure and/or transmit transmission/estimation beams based on the determined number of transmission beams and/or estimation beams

In some embodiments, a WTRU may determine direction/position/granularity of transmission beams and/or estimation beams based on the configured beam information. For example, the WTRU may divide the indicated coverage (e.g. 120 degrees) into the number of transmission/estimation beams (e.g. 12 beams) to determine position of estimation beams (e.g., 5, 15, 25, . . . , 115 degrees).

In some embodiments, a WTRU may be configured with two or more RS resource sets for partial beam measurement (e.g., one for transmission beams and/or estimation beams and one for estimation beams). The two or more RS resource sets may be configured/associated based on the one or more of the following: CSI report configuration, CSI measurement configuration, and/or CSI resource configuration. The association may be configured by RRC or indicated by MAC CE and/or DCI from a base station.

In some embodiments, for the CSI reporting configuration, two or more RS resource sets may be associated with a CSI report configuration (e.g., by configuring two or more RS resource set IDs). In some embodiments, one of the two or more RS resource sets may be associated with a CSI report configuration. For example, a first RS resource set (e.g., RS resource set for estimation beams or both estimation beams and transmission beams) may be associated with a CSI report config for beam reporting and a second RS resource set may be associated with a first RS resource set.

In some embodiments, for the CSI measurement configuration, two or more RS resource sets may be associated with a CSI measurement config (e.g., by configuring two or more RS resource set IDs). In some embodiments, only one of the two or more RS resource sets may be associated with a CSI measurement configuration. For example, a first RS resource set (e.g., RS resource set for estimation beams or both estimation beams and transmission beams) may be associated with a CSI measurement configuration for beam reporting and a second RS resource set may be associated with a first RS resource set.

In some embodiments, for the CSI resource configuration, two or more RS resource sets may be associated with a CSI resource configuration (e.g., by configuring two or more RS resource set IDs). In some embodiments, only one of the two or more RS resource sets may be associated with a CSI resource config. For example, a first RS resource set (e.g., RS resource set for estimation beams or both estimation beams and transmission beams) may be associated with a CSI resource configuration for beam reporting and a second RS resource set may be associated with a first RS resource set.

In some embodiments, a WTRU may measure a different group of beams in a transmission instance (e.g., to measure whole beams in the configuration). For example, a WTRU may measure a first group of beams in a first transmission instance, a second group of beams in a second transmission instance and estimate qualities of all configured beams (possibly not transmitted) including the first group of beams and the second group of beams. In another solution, a WTRU may transmit a different group of beams in a transmission instance (e.g., to measure whole beams in the configuration). For example, a WTRU may transmit a first group of beams in a first transmission instance and a second group of beams in a second transmission instance. The WTRU may indicate/receive one or more of the following configurations to measure/transmit beams based on beam hopping.

In some embodiments, the WTRU may receive a RS resource set for all groups of beams. In some embodiments, the WTRU may receive a configuration of all groups of beams in a RS resource set. In some embodiments, the WTRU may receive a configuration and/or an indication of beam groups. For example, the WTRU may receive one or more bitmaps wherein each of the one or more bitmaps indicates beams for each beam group. For example, ‘1’ may indicate a beam which is included in the beam group associated with the bitmap and ‘0’ may indicate a beam which is not included in the beam group.

In some embodiments, the WTRU may receive RS resource sets for transmission beams and/or estimation beams. In some embodiments, the WTRU may receive a configuration of two or more RS resource sets. For example, a first RS resource set may be for a first beam group and a second RS resource set may be for a second beam group and so on. In some embodiments, the WTRU may receive a configuration of associated beam groups. For example, the WTRU may receive a configuration of RS resource set ID of a beam group for next/previous transmissions. In some embodiments, the WTRU may receive a configuration and/or an indication which indicate a transmission order of a RS resource set.

In some embodiments, the WTRU may receive beam information for transmission beams and/or estimation beams. The beam information for transmission beams and/or estimation beams may include one or more of the following: number of all beams for whole beam groups (the WTRU may receive one configuration for each of horizontal/vertical domains); number of beams for each transmission instance (the WTRU may receive one configuration for each of horizontal/vertical domains); coverage of all beams (e.g., angular coverage such as 120 degrees); coverage of beams for each transmission instance (e.g., angular coverage such as 60 degrees); position/center of all beams (e.g., 0 degree); position/Center of beams for each transmission instance (e.g., 0 degree); and/or granularity of beams (e.g., 3 degrees) (the WTRU may receive one configuration for each of horizontal/vertical domains).

In some embodiments, the WTRU may receive beam hopping configuration. In some embodiments, the WTRU may receive beam hopping configuration for beam hopping (e.g., per WTRU or per RS resource set). The beam hopping configuration may include one or more of following: hopping periodicity; hopping time offset; hopping bandwidth; and/or hopping type (e.g., beam hopping or beam group hopping).

In some embodiments, the WTRU may report its beam information for UL RS transmission. The beam information may be one or more of the following: number of WTRU beams (the WTRU may report one configuration for each of horizontal/vertical domains); number of WTRU panels (the WTRU may report one configuration for each of horizontal/vertical domains); coverage/beam width of all beams or each beam (e.g., angular coverage such as 120 degrees); position/center of all beams or each beam (e.g., 0 degree); and/or granularity of all beams or each beam (e.g., 3 degrees) (the WTRU may report one configuration for each of horizontal/vertical domains).

In some embodiments there may be an association between two or more RS sets and UL RS triggers. For example, a WTRU may be configured with two or more RS resource sets for partial beam transmission (e.g., one for transmission beams and one for estimation beams). The two or more RS resource sets may be configured/associated with one or more configurations. For example, two or more RS resource sets may be associated with the one or more configurations (e.g., by configuring two or more RS resource set IDs).

In another example, only one of the two or more RS resource sets may be associated with a bandwidth part. For example, a first RS resource set (e.g., RS resource set for estimation beams) may be associated with a bandwidth part and a second RS resource set (e.g., RS resource set for transmission beams) may be associated with a first RS resource set.

In another example, each RS resource set may include a configuration of usage. For example, a first RS resource set may have a first usage (e.g., estimation beams) and a second RS resource set may have a second usage (e.g., transmission beams). The one or more configurations may be one or more of the following: Bandwidth part; PUSCH configuration; RS resource indicator (e.g., SRS resource indicator); and/or RS request field (e.g., SRS request field).

In some embodiments, a WTRU may determine an association between one or more beam IDs and beam information. The association may be based on the beam information configured by a base station and/or reported by the WTRU. The association may be based one or more of the following: explicit indication, order of beam direction, and/or order of panel/TRP (CORESET group ID).

In one example, a WTRU may receive an explicit indication (e.g., based on a configuration of beam information) of beam ID. For example, a WTRU may be configured with one or more beam IDs and each beam ID may comprise one or more piece of beam information (e.g., beam direction, beam width, panel/TRP ID, etc.).

In another example, a beam ID may be associated with a beam based on a direction of the beam. For example, a first beam ID may be associated with a beam with a beam direction with a lowest/highest angle (e.g., 5 degrees) and a second beam ID may be associated with a beam with a beam direction with a second lowest/highest angle and etc.

In another example, a beam ID may be associated with an order of a panel/TRP (CORESET group ID) which may comprise a beam. For example, a first beam ID may be associated with a beam with a first panel/TRP and a second beam ID may be associated with a beam with a second panel/TRP, etc.

In another example, a WTRU may determine a beam pair ID and associated beam IDs with the beam pair ID based on an explicit indication, or an implicit determination.

In an explicit indication example, the WTRU may receive an indication of one or more beam IDs associated with the beam pair ID. For example, the WTRU may receive a beam ID for common operation. For example, the WTRU may apply the beam ID for both downlink beam (e.g., DL TCI state and/or QCL Type-D) and uplink beam (e.g., UL TCI state and/or spatial relation info) for the beam pair ID. In another example, the WTRU may apply the beam ID for both TX and Rx for the beam pair ID.

In another explicit indication example, the WTRU may receive two or more beam IDs and each of the two or more beam IDs may be a beam ID for each link (e.g., one of DL, UL and SL) and/or TX/Rx (e.g., a beam ID for TX beam and another beam ID for RX beam ID).

In an implicit determination, the WTRU may determine the beam pair ID based on implicit determination methods. For example, the WTRU may determine the beam pair ID based on one or more beam IDs.

In another implicit determination example, the WTRU may determine the beam pair ID based on TX beam ID and RX beam ID. For example, the WTRU may determine the beam pair ID by multiplying the TX beam ID by the number of RX Beams and adding RX beam ID, or by multiplying the RX beam ID by the number TX beams and adding the TX beam ID.

In some embodiments, a WTRU may support WTRU reporting for partial beam measurement and/or beam hopping. The WTRU reporting may be based on one or more of following: beam indexes and/or qualities of estimated beams (possibly including transmission beams); recommendation/feedback for transmission beams; and/or WTRU report on one or more applied beams.

In some embodiments, the WTRU may report one or more beam indexes and/or qualities of estimated beams associated with the beam indexes. The beam indexes may be beam indexes of selected best/worst beams based on WTRU estimation.

In some embodiments, the WTRU may report one or more beam pair indexes and/or qualities of estimated beam pairs associated with the beam pair indexes. The beam pair indexes may be beam pair indexes of selected best/worst beams based on WTRU estimation.

In some embodiments, the WTRU may report one or more information associated with transmission/reception beams, beam pairs, and/or estimation beams. For example, the WTRU may report one or more beam indexes for transmission/reception beams. Additionally, or alternatively, the WTRU may report a ratio/portion of estimation beams and transmission/reception beams. The ratio/portion may be based on predefined relationship. For example, 0 may indicate 25%, 1 may indicate 50%, 2 may indicate 75% and 3 may indicate 100%. The WTRU determination may be based on configured/indicated thresholds by a gNB.

For example, the WTRU may report a preferred distance between transmission/reception beams (e.g., number of beams and angles). The preferred distance may be based on predefined relationship. For example, 0 may indicate 0 beam (e.g., full measurement), 1 may indicate 2 beams, 2 may indicate 4 beams and 3 may indicate 8 beams. In another example, 0 may indicate 3 degrees (e.g., full measurement), 1 may indicate 6 degrees, 2 may indicate 9 degrees and 3 may indicate 12 degrees.

In some embodiments, the WTRU may report one or more recommended beam pairs for WTRU reporting.

For example, the WTRU may be configured with a first CSI report configuration (e.g., with longer periodicity) for indicating one or more recommended beam pairs for CSI reporting and a second CSI report configuration (e.g., with shorter periodicity) for reporting preferred beam pairs. The first CSI report config and the second CSI report config may be associated based on gNB indication (e.g., via one or more of RRC, MAC CE and DCI). The WTRU may recommend a 1st Tx beam index/a 1st Rx beam index for a 1st beam pair, a 2nd Tx beam index/a 2nd Rx beam index for a 2nd beam pair and a 3rd Tx beam index/a 3rd Rx beam index for a 3rd beam pair (e.g., based on the first CSI report config). The WTRU may receive a confirmation for the recommendation (e.g., by receiving one or more of PDCCH, DCI and MAC CE). Based on the recommended beam pairs, the WTRU may indicate one or more preferred beam pairs (e.g., 2nd beam pair) for transmitting/receiving one or more channels and/or signals (e.g., based on the second CSI report config).

In some embodiments, the WTRU may report one or more recommended beam pairs for beam pair indication for transmitting/receiving one or more channels and/or signals.

For example, the WTRU may be configured with a CSI report configuration for indicating one or more recommended beam pairs. The WTRU may recommend a 1st Tx beam index/a 1st Rx beam index for a 1st beam pair, a 2nd Tx beam index/a 2nd Rx beam index for a 2nd beam pair and a 3rd Tx beam index/a 3rd Rx beam index for a 3rd beam pair (e.g., based on the first CSI report config). The WTRU may receive a confirmation for the recommendation (e.g., by receiving one or more of PDCCH, DCI and MAC CE). Based on the recommended beam pairs, the WTRU may receive one or more beam pair indications (e.g., beam pair ID) for transmitting/receiving one or more channels and/or signals.

For example, the WTRU may be configured with a CSI report configuration for indicating one or more recommended beam pair IDs. The WTRU may indicate one or more preferred beam pairs (e.g., a 1st beam pair, a 2nd beam pair and a 3rd beam pair) for transmitting/receiving one or more channels and/or signals (e.g., based on the CSI report configuration). The WTRU may receive a confirmation for the recommendation (e.g., by receiving one or more of PDCCH, DCI and MAC CE). Based on the reported beam pairs, the WTRU may receive one or more beam pair IDs (e.g., the 2nd beam pair) for transmitting/receiving one or more channels and/or signals (e.g., based on the second CSI report configuration).

For example, a WTRU may determine one or more beam (or TCI states) for transmitting/receiving one or more channels and/or signals based on the reported beam pairs by the WTRU. For example, the WTRU may recommend a 1st beam pair associated with a 1st Tx beam index/a 1st Rx beam index, a 2nd beam pair associated with a 2nd Tx beam index/a 2nd Rx beam index and a 3rd beam pair associated with a 3rd Tx beam index/a 3rd Rx beam index. The WTRU may receive a confirmation for the recommendation (e.g., by receiving one or more of PDCCH, DCI and MAC CE). Based on the reported beam pairs, the WTRU may determine one or more beams (e.g., the 1st Tx beam, the 2nd Tx beam and the 3rd Tx beam and/or the 1st Rx beam, the 2nd Rx beam and the 3rd Rx beam) for beam indication. The WTRU may receive one or more beams of the one or more determined beams (e.g., the 2nd Tx beam and/or the 2nd Rx beam) for transmitting/receiving one or more signals and/or channels (e.g., via one or more of RRC, MAC CE and DCI).

Additionally, or alternatively, the WTRU may indicate whether the estimation is accurate or not. For example, 1 may indicate the estimation is accurate (e.g., if measured accuracy is higher than a threshold) and 0 may indicate the estimation is not accurate (e.g., if measured accuracy is lower than (or equal to) the threshold). The WTRU determination may be based on a configured/indicated threshold by a gNB. In some embodiments, based on the WTRU recommendation, the WTRU may apply the reported beam indexes and/or the reported ratio/portion after transmitting the WTRU report and processing time (e.g., N symbols/ms from the WTRU report). In some embodiments, based on the WTRU recommendation, the WTRU may receive a confirmation of the WTRU recommendation (e.g., via a CORESET associated with the CSI report config). For example, the WTRU may apply the reported beam indexes and/or the reported ratio/portion after receiving the confirmation and processing time (e.g., N symbols/ms from the confirmation). In another example, if the WTRU reports the estimation does not work well, the WTRU may receive full beam measurement.

In some embodiments, the WTRU may report quality of one or more applied beams. The WTRU may receive a configuration/indication which indicates whether the report is needed or not (e.g., from a gNB). For example, the WTRU may apply an estimation beam for receiving one or more channels (e.g., PDSCHs). For example, the WTRU may report a quality (e.g., RSRP, RSRQ, SINR or PDCCH hypothetical BLER) of the applied estimation beam. The WTRU may measure and report the quality by measuring DMRS of the one or more channels. Additionally, or alternatively, the WTRU may report an accuracy of the applied estimation beam. For example, the WTRU may report an accuracy of a quality of the applied beam and the estimation beam. The accuracy may be based on a predefined relationship. For example, 0 may indicate 25%, 1 may indicate 50%, 2 may indicate 75% and 3 may indicate 100%. The WTRU determination may be based on thresholds configured and/or indicated by a gNB.

Additionally, or alternatively, the WTRU may report a difference of a quality of the applied beam and the estimation beam. The accuracy may be based on predefined relationship. For example, 0 may indicate 0 dB, 1 may indicate 3 dB, 2 may indicate 6 dB and 3 may indicate 12 dB. The WTRU determination may be based on thresholds configured and/or indicated by a gNB. Additionally, or alternatively, the WTRU may indicate whether the estimation works or not. For example, 1 may indicate the estimation works well and 0 may indicate the estimation does not work. The WTRU determination may be based on thresholds configured and/or indicated by a gNB.

In some embodiments, the beam indexes may be reported by using a Beam ID, a CSI-RS resource indicator (CRI) and/or a synchronization signal block resource indicator (SSBRI). For beam indexes of WTRU reporting, the beam indexes may be determined based on configured/indicated beam information. In some embodiments, the WTRU may determine the beam index based on number of estimation beams. For example, the WTRU may identify a beam index of estimation/transmission beams based on angular position of each beam. Additionally, or alternatively, the beam indexes can be determined based on a configured/indicated beam type. In some embodiments, the WTRU may determine the beam index based on a type of beam. For example, the WTRU may determine a lower beam index and/or a lower group of beam indexes for transmission beams and the WTRU may determine a higher/lower group of beam index for estimation beams.

Additionally, or alternatively, the beam indexes may be determined based on a configuration of associated CSI report configuration/CSI measurement configuration/CSI resource configuration. For example, if the WTRU is configured with one or more of CSI report configurations/CSI measurement configurations/CSI resource configurations (e.g., for a RS resource set), the WTRU may determine a lower beam index and/or a lower group of beam indexes (e.g., for the RS resource set). If the WTRU is configured without CSI report configuration/CSI measurement configuration/CSI resource configuration (e.g., for a RS resource set) the WTRU may determine higher/lower group of beam index (e.g., for the RS resource set).

In some embodiments, a WTRU may report different types of beam indexes based on beam types. For example, if a WTRU reports beam indexes based on transmission beams, the WTRU may report RS index (e.g., CRI, SSBRI or SRI). If the WTRU reports beam indexes based on estimation beams, the WTRU may report beam IDs. The WTRU may indicate whether the WTRU reports RS indexes or beam IDs. For example, the WTRU may report one bit to indicate whether the WTRU reports RS indexes or beam IDs (e.g., 0 my indicated RS indexes and 1 may indicate beam IDs).

In some embodiments, a WTRU may report whether the WTRU supports partial beam measurement, beam hopping and corresponding WTRU reporting. In an example, the capability indication may be one signaling which indicates WTRU support for partial measurement/beam hopping and corresponding WTRU reporting. In another example, the capability indication may be an independent signaling which indicates support of partial measurement/beam hopping and WTRU reporting separately.

In some embodiments, a WTRU may be configured with one or more UL resources for WTRU reporting. The one or more UL resources may be one or more of the following: PUCCH, PUSCH, PRACH, SRS, MAC CE, and/or RRC.

In some embodiments a WTRU may determine one or more beams to be used for receiving/transmitting one or more channels and/or signals based on partial measurement/transmission. For example, the WTRU may receive an indication of one or more beam RSs (e.g., for full measurement or transmission beams) and/or one or more beam IDs (e.g., for partial measurement or estimation beams). The indication may be based on TCI states. For example, each TCI state may comprise one or more beam RSs and/or one or more beam IDs and the WTRU may receive an indication of a TCI state from a gNB (e.g., via DCI and/or MAC CE) to determine beam RSs and/or beam IDs to be used for transmission/reception beams.

In some embodiments a WTRU may receive an indication of beam determination type. For example, the WTRU may receive an indication of one or more beam RSs and one or more beam IDs in a TCI state. If the WTRU determines beam indication based on beam RSs, the WTRU may use the one or more beam RSs for transmission/reception beam determination. If the WTRU determines beam indication based on one or more beam IDs, the WTRU may use the one or more beam IDs for transmission/reception beam determination. In another example, each TCI state may comprise one or more beam RSs and one or more beam IDs may be explicitly indicated to the WTRU (e.g., via one or more of RRC, MAC CE and DCI) based on the determined beam determination type.

The indication may be based on one or more of: an explicit indication, CSI reporting type, or WTRU reporting.

If the indication is an explicit indication, the WTRU may receive an indication indicating whether the beam determination is based on one or more beam IDs, or one or more TCI states. For example, 0 may indicate beam RS based beam determination/indication and 1 may indicated beam ID based beam determination/indication. The WTRU may receive the indication based on one or more of RRC, MAC CE and DCI.

In another example of explicit indication, the WTRU may report the WTRU's preference on beam determination. For example, 0 may indicate beam RS based beam determination/indication and 1 may indicated beam ID based beam determination/indication (e.g., via CSI reporting). The WTRU may indicate the preference based on one or more of RRC, MAC CE, and DCI.

If the indication is CSI reporting type, the WTRU may receive an indication indicating whether the WTRU reports CRI/SSBRI or beam ID for CSI reporting (e.g., via one or more of RRC, MAC CE and DCI). If the WTRU receives an indication of CRI/SSBRI based reporting, the WTRU may use beam RSs for beam determination. If the WTRU receives an indication of beam ID based reporting, the WTRU may use beam IDs for beam determination.

If the indication is WTRU reporting, the WTRU may report the WTRU's preference on beam determination. The report may be based on one or more of RRC, MAC CE, DCI and CSI reporting. For example, 0 may indicate beam RS based beam determination/indication and 1 may indicated beam ID based beam determination/indication.

For example, the WTRU may report the WTRU's preference on CSI reporting. The report may be based on one or more of RRC, MAC CE, DCI, and CSI reporting. For example, 0 may indicate CRI/SSBRI based reporting and 1 may indicated beam ID based reporting. If the WTRU reports an indication of CRI/SSBRI based reporting, the WTRU may use beam RSs for beam determination. If the WTRU reports an indication of beam ID based reporting, the WTRU may use beam IDs for beam determination.

The WTRU may receive a confirmation (e.g., via receiving one or more PDCCHs in a CORESET/search space possibly associated with the WTRU reporting).

In some embodiments, the WTRU may determine one or more processing times based on a type of beam indication. For example, the WTRU may determine a first processing time if the WTRU receives a beam indication based on the first beam indication type (e.g., beam ID and/or TCI state ID). The WTRU may determine a second processing time if the WTRU receives a beam indication based on the second beam indication type (e.g., beam pair ID, unified TCI state and/or TCI state group ID).

The processing time may include one or more of following: time offset between PDCCH and PDSCH/PUSCH with same/different SCSs; time offset between PDSCH and ACK/NACK with same/different SCSs; TCI state indication delay (e.g., timeDurationForQCL) and/or TCI state activation delay; time offset between PDCCH and CSI report; time offset between CSI-RS/IM and CSI report; Scell activation delay; and/or time offset between PDCCH and RS transmission.

In some embodiments, a WTRU may perform a measurement of one or more beam reference signals (e.g., CSI-RS, SSB, TRS, and SRS) and the WTRU may estimate, predict, or determine one or more beam indexes which may be associated with one or more time resources later than the time resource where the beam reference signals are measured. For example, a WTRU may perform a measurement of one or more beam reference signals at a time slot #n, the WTRU may estimate, predict, or determine preferred beam indexes at time slots #n+k (hereafter, referred to as a future time slot), wherein k may be a positive integer number.

In some embodiments, the WTRU may perform the beam estimation, prediction, and determination for one or more future time slots by using Al/ML model which may be trained online/offline. An estimation beam may be based on an Al/ML model. The Al/ML model may be based on measurements of transmission beams.

In some embodiments, the beam indexes may be reported with its associated time slots. For example, a WTRU may measure beam reference signals at a time slot (e.g., #n) and the WTRU may report preferred beam indexes for one or more time slots later than the time slot where the beam reference signals measured (e.g., #n+k1, #n+k2, #n+k3). If three preferred beam indexes (e.g., CRI) are reported, each beam index may be reported with its associated time slot information as {CRI1, k1}, {CRI2,k2}, and {CRI3, k3}. The number of time slots for which beam indexes are predicted, estimated, or determined based on a measurement of beam reference signals at a time slot (or one or more time slots) may be determined based on one or more of following: channel condition (e.g., Doppler frequency, channel coherence time); reporting periodicity (e.g., beam reporting cycle or duration for periodic or semi-persistent beam reporting); beam reference signal periodicity (e.g., beam reference signal time frequency); AI/ML prediction accuracy (for example, if AI/ML prediction accuracy is above a threshold, a first number of time slots may be predicted and reported; otherwise, a second number of time slots may be predicted); and/or the number of time slots may be interchangeably used with time window and time duration. The one or more future time slots (e.g., k1, k2, k3) may be configured or indicated by gNB and the WTRU may report its associated beam indexes. When a WTRU measures beam reference signals in one or more time slots, the slot #n may be the last slots of the one or more time slots.

In some embodiments, beam reference signals measured in a time slots may be a subset of full beams, wherein full beams may be referred to as the total number of beams to be measured, estimated, or predicted and at least one of the full beams may be reported as a preferred or determined beam by a WTRU.

In some embodiments, a WTRU may perform a prediction of one or more beams for future time slots and the WTRU may determine or estimate an accuracy level of the prediction.

In some embodiments, a WTRU may report the accuracy level by configuration. For example, a WTRU may be configured (e.g., via RRC and/or MAC-CE) to report the accuracy level with a time periodicity (e.g., periodic, semi-persistent).

Additionally, or alternatively, a WTRU may report the accuracy level by indication. For example, a WTRU may be dynamically indicated to report the accuracy level in a DCI (e.g., UL grant or DL scheduling DCI)

Additionally, or alternatively, a WTRU may report the accuracy level when one or more of the following conditions are met: prediction accuracy level is below a threshold; prediction accuracy level meets a certain requirement; need more beam reference signals (e.g., in spatial domain and/or time domain) to meet a required prediction level; AI/ML model needs to be retrained; and/or beam change rate is higher than a threshold (e.g., WTRU to WTRU mobility).

Additionally, or alternatively, a WTRU may report the accuracy level based on each beam reporting, if prediction is used. For example, a WTRU may report beam indexes for future time slots with its accuracy level, wherein the accuracy level may be a latest accuracy level determined.

In some embodiments, a beam prediction accuracy level may be determined based on a difference between a predicted beam for a slot #n+k and the measured beam at the slot #n+k. For accuracy level estimation, a WTRU may receive beam reference signals at the slot #n+k for which the WTRU may predict a beam in an earlier slot. A time window may be configured or defined in which beam accuracy level may be estimated or determined.

Additionally, or alternatively, the beam prediction accuracy level may be determined based on beam quality of the predicted beam in the future slots. For example, if the predicted beam quality is below a threshold at the time slot associated, the WTRU may determine that the accuracy level may be below a threshold.

Additionally, or alternatively, the beam prediction accuracy level may be determined based on a number of NACKs for PDSCH and/or PUSCH determined or received. In further embodiments, the beam prediction accuracy level may be determined based on a number of consecutive NACKs for PDSCH and/or PUSCH determined or received.

Additionally, or alternatively, the beam prediction accuracy level may be determined based on a quality of beams associated with CORESETs configured for a BWP (or active BWP).

Additionally, or alternatively, the beam prediction accuracy level may be determined based on a quality of beam failure detection RS (e.g., q0).

In some embodiments, when the beam prediction accuracy is below a threshold, a WTRU may perform one or more of following: the WTRU may skip reporting preferred beam indexes for future time slot(s); the WTRU may indicate to gNB the beam prediction accuracy/quality is below a threshold; the WTRU may report preferred beam for the current time slot (e.g., slot #n) where the WTRU measured beam reference signals; the WTRU may switch to a beam reporting mode without prediction (e.g., fallback mode); and/or the WTRU may request shorter beam reference signal transmission.

In some embodiments, a WTRU may determine time/frequency synchronization for partial beam measurement and beam hopping. For example, the WTRU may determine RSs for time/frequency synchronization (e.g., one or more of SSBs, tracking RSs (TRSs) and CSI-RS for tracking) based on one or more of the following: associated beam group and/or time/frequency synchronization estimation.

In some embodiments, the WTRU may determine RSs for time/frequency synchronization based on an associated beam group. For example, the WTRU may receive a configuration and/or an indication of time/frequency synchronization RSs for each beam group. Based on the configuration and/or the indication. In addition, the WTRU may receive a configuration and/or an indication of a beam group index for each beam (e.g., a RS resource set ID), the WTRU may identify an associated beam group index for each beam and an associated synchronization RSs to identify time/frequency synchronization for each beam.

In some embodiments, the WTRU may determine one or more time/frequency synchronization RSs (e.g., associated with an estimation beam). For example, if the WTRU is configured with a first beam (transmission beam), a second beam (estimation beam) and a third beam (transmission beam). The WTRU may estimate time/frequency synchronization of the second beam based on time/frequency synchronization RSs of the first beam and the second beam. For example, interpolation, linear regression, or super-resolution methods may be used.

In some embodiments, a WTRU may report WTRU Rx beam information. The beam information may be based on one or more of the following: number of WTRU beams (the WTRU may report one configuration for each of horizontal/vertical domains); number of WTRU panels (the WTRU may report one configuration for each of horizontal/vertical domains); coverage/beam width of all beams or each beam (e.g., angular coverage such as 120 degrees); position/center of all beams or each beam (e.g., 0 degree); and/or granularity of all beams or each beam (e.g., 3 degrees) (the WTRU may report one configuration for each of horizontal/vertical domains).

Based on the reported information, the WTRU may determine WTRU beam indexes. For example, the WTRU may identify a beam index of estimation/transmission beams based on angular position of each beam. In another example, the WTRU may determine the beam index based on a panel ID. For example, the WTRU may determine lower/lower group of beam index for WTRU beams for a first panel and the WTRU may determine higher/lower group of beam index for WTRU beams for a second panel.

Based on the reported information, the WTRU may receive an indication of WTRU reception beam (e.g., for receiving one or more channels and/or signals) from a gNB.

In some embodiments, the WTRU may receive an explicit indication of WTRU beam index (e.g., in a WTRU specific DCI or a group specific DCI).

Additionally, or alternatively, the WTRU may receive a WTRU reception beam index configured in a TCI state. For example, the WTRU may receive an indication of WTRU beam index based on a configured WTRU beam index in a TCI state. Based on the indication, the WTRU may identify a WTRU beam the WTRU needs to apply for receiving one or more channels and/or signals.

Additionally, or alternatively, the WTRU may receive a WTRU reception beam index configured in one or more of CSI report configuration, CSI measurement configuration and CSI resource configuration. For example, the WTRU may receive an indication of WTRU beam index based on a configured WTRU beam index in a CSI report configuration, a CSI measurement configuration or a CSI resource configuration. Based on the indication, the WTRU may identify a WTRU beam the WTRU needs to apply for receiving one or more channels and/or signals.

Additionally, or alternatively, the WTRU may receive a WTRU reception beam index configured in a RS resource set. For example, the WTRU may receive an indication of WTRU beam index based on a configured WTRU beam index in a RS resource set. Based on the indication, the WTRU may identify a WTRU beam the WTRU needs to apply for receiving one or more channels and/or signals.

In some embodiments, a WTRU may report reception beam for measuring one or more RSs (e.g., when the WTRU reports beam indexes and/or corresponding qualities by measuring the one or more RSs).

In some embodiments, the WTRU may report one WTRU reception beam for all reported beam indexes. For example, the WTRU may report one WTRU reception beam which may apply all reported beam indexes.

Additionally, or alternatively, the WTUR may report two or more WTRU reception beams. In some embodiments, a first WTRU reception beam may be used for a first group of reported beams and a second WTRU reception beam may be used for a second group of reported beams. In some embodiments, the WTRU may report two or more WTRU reception beams only for M best/worst beams.

In the embodiments disclosed below, fingerprinting may refer to characteristics and/or statistics of received signal and/or measurement thereof. In some embodiments, fingerprinting may include statistics of RS measurements over plurality of transmit-receive beam pairs. In other embodiments, fingerprinting may include statistics of RS measurements over plurality of transmit-receive beam pairs associated with a specific WTRU location and/or time period. A WTRU may report one or more statistics associated with measurement of first RS resource subset which implicitly indicates one or more statistics associated with measurement of second RS resource subset.

In some embodiments, a WTRU may recommend one or more preferred signal processing methods based on WTRU measurements. The recommendation may be determined by measuring one or more RS resource sets (e.g., for estimation beams and/or transmission beams). For example, the WTRU may measure one or more RS resource sets and may determine a signal processing method which is best for estimating configured estimation beams. Based on the determination, the WTRU may report one or more of preconfigured/predefined signal processing methods. For example, the WTRU may indicate one of reverse-fingerprinting or super-resolution. Based on the WTRU indication, the WTRU may apply reported signaling method for WTRU reporting and/or gNB determination based on one or more of the following.

In some embodiments, based on the WTRU recommendation, the WTRU may apply the reported signaling method after transmitting the WTRU report and processing time (e.g., N symbols/ms from the WTRU report). For example, the WTRU may report preferred fingerprint for reverse fingerprinting.

Additionally, or alternatively, the WTRU may receive a confirmation of the WTRU recommendation (e.g., via a CORESET associated with the CSI report config). For example, the WTRU may apply the reported signal processing method after receiving the confirmation and processing time (e.g., N symbols/ms from the confirmation).

In some embodiments, a WTRU may recommend one or more preferred fingerprints based on WTRU measurement (e.g., measurement of one or more RS resource sets) and/or WTRU position. The one or more fingerprints may be selected from configured fingerprints and/or predefined fingerprints. The WTRU may report one or more indexes of the one or more fingerprints. The indexes of the fingerprints may be determined based on one or more of the following: predefined order and/or based on gNB configuration (e.g., configured order or explicit configuration of fingerprint ID).

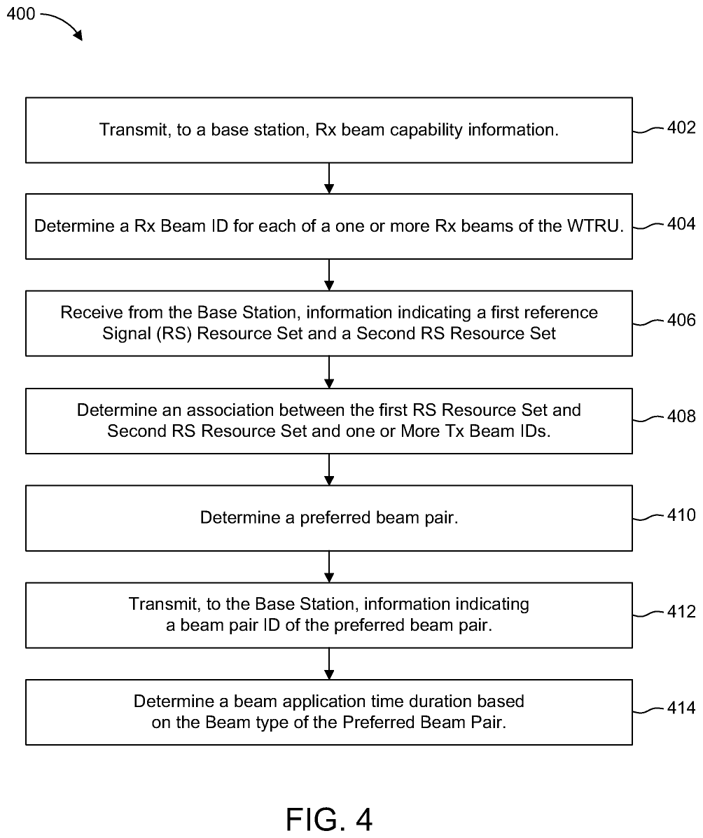

FIG. 4 illustrates an example of a procedure 400 for beam management based on partial measurement. At 402, a WTRU may transmit, to a base station, Rx beam capability information. At 404, the WTRU may determine a Rx beam ID for each of one or more Rx beams of the WTRU. At 406, the WTRU may receive from the base station, information indicating a first reference signal (RS) resource set and a second RS resource set. At 408, the WTRU may determine an association between the first RS resource set and second RS resource set and one or more Tx beam IDs. At 410, the WTRU may determine a preferred beam pair, including a preferred Rx beam and preferred Tx beam. At 412, the WTRU may transmit, to the base station, information indicating a beam pair ID of the preferred beam pair. At 414, the WTRU may determine a beam application time based on the preferred beam pair based on a beam type of the preferred beam pair.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed by a wireless transmit/receive unit (WTRU), the method comprising:
transmitting, to a base station, Rx beam capability information;
determining a Rx beam ID for each of a one or more Rx beams of the WTRU;
receiving, from the base station, information indicating a first reference signal (RS) resource set and a second RS resource set;
determining an association between the first RS resource set and second RS resource set and one or more Tx beam IDs;
determining a preferred beam pair, including a preferred Rx beam and a preferred Tx beam; and
transmitting, to the base station, information indicating the preferred beam pair.

2. The method of claim 1, further comprising, determining a beam application time duration based on a beam type of the preferred beam pair.

3. The method of claim 2, wherein the beam type is a transmission beam or an estimation beam.

4. The method of claim 3, wherein the estimation beam is based on a machine learning model.

5. The method of claim 4, wherein the machine learning model is based on measurements of transmission beams.

6. The method of claim 2, further comprising receiving, using the preferred Rx beam, a physical downlink shared channel (PDSCH) transmission during the beam application time duration.

7. The method of claim 1, wherein the Rx beam capability information includes at least one of a number of a WTRU beams, a number of WTRU panels, a beam width, a beam position, or a beam granularity.

8. The method of claim 1, wherein the first RS resource set includes one or more RS resources for transmissions beams and the second RS resource set includes one or more RS resources for estimation beams.

9. The method of claim 1, wherein the association between the first RS resource set and the second resource set and the Tx beam IDs is based on a beam configuration information.

10. A wireless transmit/receive unit (WTRU) comprising:
a transceiver for sending and receiving signals; and
a processor cooperatively coupled to the transceiver,
the processor and transceiver configured to:
transmit, to a base station, Rx beam capability information;
determine a Rx beam ID for each of one or more Rx beams of the WTRU;
receive, from the base station, information indicating a first reference signal (RS) resource set and a second RS resource set;
determine an association between the first RS resource set and the second RS resource set and one or more Tx beam IDs;
determine a preferred beam pair, including a preferred Rx beam and a preferred Tx beam; and
transmit, to the base station, information indicating the preferred beam pair.

11. The WTRU of claim 10, wherein the processor and transceiver are further configured to determine a beam application time duration based on a beam type of the preferred beam pair.

12. The WTRU of claim 11, wherein the beam type is a transmission beam or an estimation beam.

13. The WTRU of claim 12, wherein the estimation beam is based on a machine learning model.

14. The WTRU of claim 13, wherein the machine learning model is based on measurements of transmission beams.

15. The WTRU of claim 11, wherein the processor and transceiver are further configured to receive, using the preferred Rx beam, a physical downlink shared channel (PDSCH) transmission during the beam application time duration.

16. The WTRU of claim 10, wherein the Rx beam capability information includes at least one of a number of a WTRU beams, a number of WTRU panels, a beam width, a beam position, or a beam granularity.

17. The WTRU of claim 10, wherein the first RS resource set includes one or more RS resources for transmissions beams and the second RS resource set includes one or more resources for estimation beams.

18. The WTRU of claim 10, wherein the association between the first RS resource set and the second resource set and the Tx beam IDs is based on a beam configuration information.

19. The method of claim 1, wherein the information indicating the preferred beam pair includes a beam pair ID of the preferred beam pair.

20. The WTRU of claim 10, wherein the information indicating the preferred beam pair includes a beam pair ID of the preferred beam pair.
